(19) United States
(12) Patent Application Publication
(10) Pub. No.: US 2022/0356090 A1
(43) Pub. Date: Nov. 10, 2022

(54) FACILITY-BASED WASTEWATER TREATMENT, REUSE,WASTE DISPOSAL PROCESS.

(71) Applicant: VEJAY KUMAR, WIMAUMA, FL (US)

(72) Inventor: VEJAY KUMAR, WIMAUMA, FL (US)

(21) Appl. No.: 17/741,344

(22) Filed: May 10, 2022

Related U.S. Application Data
(60) Provisional application No. 63/186,553, filed on May 10, 2021.

(51) Int. Cl. C02F 1/76; C02F 1/00

(52) U.S. Cl. CPC C02F 1/76; C02F 1/004; C02F 2103/005

(57) ABSTRACT

A facility-based domestic wastewater treatment system equipped with modified toilets and a hypochlorous acid machine, neutralizing coliform bacteria from bodily excretions at the source. The treated batch content in the toilet is flushed to a secondary process tank equipped with a grinding pump, hypochlorous acid dispensing nozzles and solenoid valves. Toilet and other facility utilities wastewater are treated and discharged to a filtration system to be separated. The filtration system is capable of separating bacteria and other particulates up to or equal to a fineness of 0.01 microns. Separate storage tanks are used to store recovered and reclaimed water in conjunction with a slurry waste collection tank for solid waste disposal. A facility-based wastewater reclamation system utilizing Reverse Osmosis process to remove unwanted contaminants and dissolved solids producing potable water, some of which is further processed with UV, and Ozone treatment to be used as drinking and cooking water.

### CROSS-REFERENCED TO RELATED APPLICATION

This Provisional application is a continuation application and claims priority from U.S. Provisional application No. 63/186,553 filed on May 10, 2021 by Vejay Kumar and entitled Instant neutralization, treatment, processing and disposal of human excrement and whole house process water treatment and sanitation, which is incorporated herein by reference for all purposes.

### BACKGROUND OF THE INVENTION

1. Field of Art to which Invention Pertains.

The field of art pertains to the public health system of domestic wastewater treatment and disposal.

### 2. The State of Prior Art Known to Inventor.

The current domestic wastewater treatment process has a vast network of sewer pipes, sewer trenches, pumping/lift stations and treatment plants. The sewer network collects the wastewater from homes and other facilities, (commercial residential facilities, schools, universities, businesses) connected to the sewer network. Solid wastes separated and removed from the wastewater and biologically processed. Wastewater filtered and chemically treated to neutralize harmful pathogens and bacteria.

The treated wastewater disposed in oceans, rivers and other suitable bodies of water and a portion reused.

Black raw water has fecal sludge and urine whilst gray water is made up of kitchen, laundry, face-sink, and bath water. Improperly treated wastewater can have a negative impact on the environment and human health; harm to fish life, oxygen depletion, beach closures, contamination of ground water, surface fresh water and drinking water. The safe treatment and disposal of wastewater and sludge is of paramount importance to prevent the spread of waterborne infectious diseases.

3. Problems Involved with the Prior Art.

The current system contributes to environmental contamination of ground water, surface water, saltwater contamination and global freshwater shortages. It also aids the spreading of water borne pathogens and infectious diseases and contributes to the global carbon footprint. Wastewater treatment plants (WWTP's) produce greenhouse gasses, carbon dioxide (CO2), methane (NH4) and nitrous oxide (N2O) during the biological treatment process. Carbon dioxide gases also emitted during the production of energy needed for plant operation. A vast amount of energy is needed to operate the water treatment plants and most of the energy consumed are obtained from carbon-based fuels. The burning of carbon-based fuels to create energy necessary to operate the approximately 16000 plants in the U.S. and its territories produces copious amounts of carbon dioxide which contributes to the global warming. It is of utmost importance that the shortcomings of the current state of art be addressed immediately.

4. Problems Involved with the Prior Art and Solutions Offered by the Invention.

The sewer and septic system are the perfect habitat for the continuous growth and sustenance of harmful bacteria, pathogens, viruses, helminths, and protozoa. They colonize the wastewater and use it as a vehicle to transfer from the sewer to ground water during uncontrollable spills that occur often. These harmful contaminants contaminate ground and surface water causing the spread of infectious diseases.

The following are diseases caused by bacteria found in wastewater. Gastroenteritis, blood strained diarrhea, hemolytic uremic syndrome, peptic ulcers, abdominal pain, gastric cancer, salmonellosis, typhoid fever, dysentery, and cholera.

The following are diseases caused by Helminths found in wastewater. Roundworm, hookworm, liver fluke, blood fluke, whipworm, and tapeworm.

The following are diseases caused by protozoa found in wastewater. Dysentery, persistent diarrhea, amoebic dysentery, and giardiasis.

The following are diseases caused by viruses found in wastewater. Eye infections, respiratory disease, gastroenteritis, aseptic meningitis, herpangina fever, respiratory illness, heart and kidney disease, rash, and infectious hepatitis.

CDC epidemiologists' comprehensive estimates of water borne diseases in the USA annually: 7.15 million in illness, 6,630 deaths and an annual cost of $3.3 billion. Dec. 15, 2020. (Source:—CDC's Burden of Waterborne Disease Estimate-NACCHO).

The patent concept shall end the need for sewers and septic collection systems. The change from sewer and septic processing shall reduce the spread of waterborne pathogens resulting in the reduction of infectious diseases associated with these processes.

Daily continuous environmental contamination caused by the dumping of treated wastewater into rivers and oceans and sludge landfills leaching and contaminating ground source water. To fully understand the gravity of the amount of wastewater being dumped, research revealed that the city of El Segundo Los Angeles has a plant on a bluff overlooking the Santa Monica Bay, which treats and discharges 260 million gallons of water into the ocean via a pipe, that runs 5 miles offshore, daily. Research has revealed that there are more than 16000 publicly owned wastewater treatment plants that operate in the United States and its territories. Each plant oversees the disposal of treated wastewater to the oceans, rivers, and lakes etc.

USGS freshwater and saline water (seawater and brackish coastal water) withdrawals in the US in 2015 totaled approximately 322 billion gallons (1.2 trillion litters) per day. Water withdrawal were as follows: 61.5% or 198 billion gallons of water (750 billion liters) per day came from surface water such as lakes, rivers, and streams. Approximately a quarter of freshwater withdrawals 82 billion gallons (310 billion liters) came from ground water and the remaining 13 percent came from saline sources.

Source:—Ensia.com Report from the U.S. Geological Survey. Feb. 22, 2019.
Of this withdrawal approximately 50% reused and 50% treated as wastewater and returned to the environment. Augment this wastewater disposal globally to fully understand the freshwater abuse and why there will be a global freshwater shortage if we do not address this problem immediately. Source:—National Geographic.Com Why is America running out of water. Aug. 12, 2020

The patent concept will stop environmental contamination caused by current wastewater treatment and disposal methods. There will be a reduction in the volume of disposed wastewater, because of storage and reuse. Facility-based excess recovered wastewater can be piped to transfer supply lines for possible use in housing subdivision irrigation projects, golf courses, pools, farms or other uses. Treated wastewater sent to soak aways shall percolate through the soil as ground water free of harmful pathogens and bacteria.

To compound the wastewater disposal dilemma; the rate of disposal of treated wastewater is greater than the natural precipitation replenishment rates for ground water in high density residential areas. This is resulting in drought conditions and is contributing to the rapid shrinkage of the natural water table in these high-density residential areas. Patent concept returns treated wastewater to the soil thus increasing ground water replenishment rates.

Research has revealed that South Jersey water table is shrinking at an alarming rate annually. Source:—www.usgs.gov. Groundwater decline and depletion. Jun. 6, 2018.

The rapid depletion of freshwater sources globally is the next big global freshwater shortage predicted by the World Health Organization. Of the world's major aquifers (gravel and sand filled reservoirs) 21 of 37 are receding; from India and China to the United States and France. Senior NASA water scientist has warned that “the water table is dropping all over the world.” The current method of disposing treated wastewater in oceans, rivers and other bodies of water is contributing to and accelerating global freshwater shortages. Source:—www.bbc.com. Is the world running out of freshwater?

Patent concept will solve the freshwater shortage because of rapid return of treated wastewater to the ground source, storage, and reuse of recovered wastewater. The recovery, reclamation and reuse of treated wastewater will result in reduced daily demand for city supplied water.

Energy consumption of these plants are extremely high and expensive. Research has revealed the following: “Across the country, municipal wastewater treatment plants are estimated to consume more than 30 terawatt hours per year of electricity, 1 which equates to about $2 billion in annual electric costs”.

Source:—www.energy.gov—Energy Data Management Manual for the Wastewater Treatment Sector.

Patent concept shall use less energy to process unit daily fecal and urine discharge per person when compared to current wastewater treatment methods primarily because of using hypochlorous acid as the neutralizing agent and minimal electrical power requirements for treatment processing.

### SUMMARY OF INVENTION

### 1. Exact Nature, Operation, and Purpose of Invention.

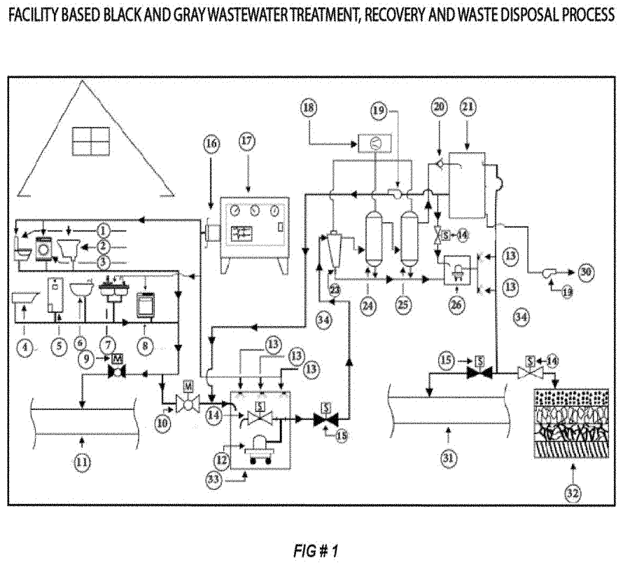

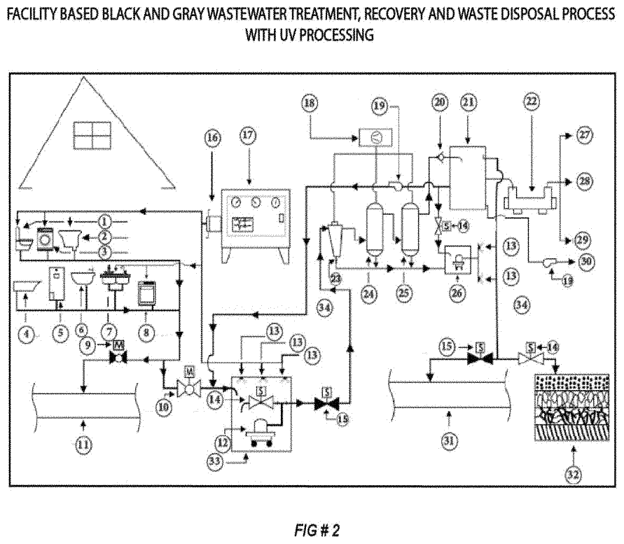

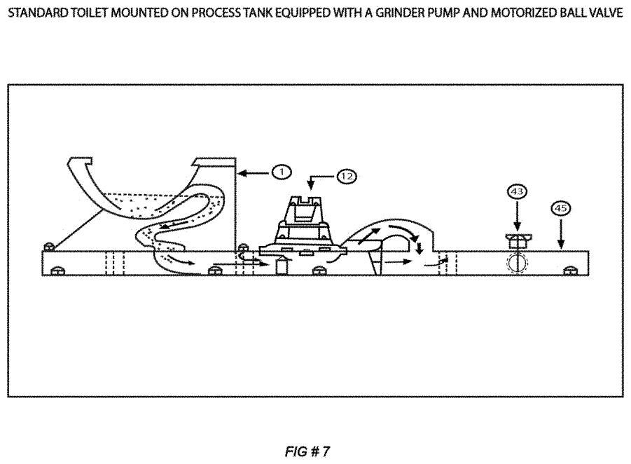

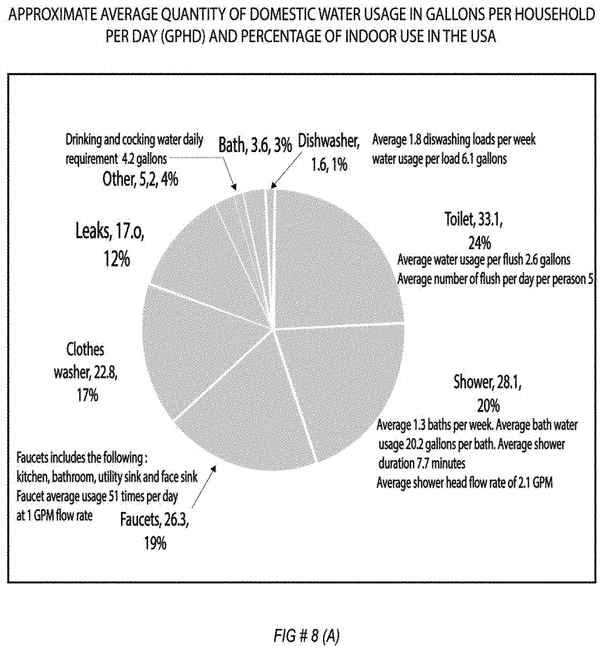

Facility-based chemical neutralization FIG. 1. thru FIG. 5. illustrates a process in which fecal, urine and other household waste discharges are chemically treated and macerated, rapidly neutralizing harmful coliform bacteria and other pathogens in domestic wastewater at the source.

The use of modified toilets equipped with motor driven cutting blades, process tanks, grinder pump, Hypochlorous Acid Chemical Producing Machine, chemical metering pump and air assisted backwash spin down mechanical filter, membrane filters and hollow tube ceramic nano filters to aid with the processing, recovery and reuse of treated wastewater and slurry waste disposal.

The filtration process separates treated domestic wastewater into recovered water and backwashed fertilizer slurry waste and allows storage and reuse of recovered wastewater. The solid daily waste estimated to be 93.5 grams per fecal and urine discharge per person. The slurry waste can be safely managed and disposed of in many ways. A simple method of disposal of wastewater slurry waste is to pump the waste into a perforated basket and allow the wastewater to drain to the soak away leaving a residue mixture of grounded toilet paper mixed with fecal and urine solids and other facility utility waste. This residue can be used wet or dried as a soil amendment. This system illustrates the patent concept of a modern, energy efficient method to process domestic black and gray wastewater at the source in real time. The proposed facility-based system is to serve as a replacement wastewater treatment process in new home construction and in existing homes, multifamily high-rise dwellings, hotels, schools, universities, farms, and other suitable areas of use.

2. Subject Matter of Invention should be Described in One or More Paragraphs.

This proposed process treatment rapidly neutralizes the coliform bacteria and other associated pathogens at the processing source, killing or making harmless within the treated batch mixture.

The batch mixture of fecal mass, urine, other bodily excretions, and cleaning tissue macerated and chemically treated in modified toilets flushed and sent to secondary process tanks for further processing. A precise amount of hypochlorous acid, at concentration of 100-200 PPM, dispersed into the process tank via spray nozzles affixed into the cover of tank to neutralize a fixed amount of wastewater (suggested batch-size of 25 gallons) inclusive of toilet and other facility-based utility wastewater discharges. The batch contents macerated and recirculated using grinder pump ensuring thorough mixing and neutralizing of wastewater contents with process chemical hypochlorous acid, rendering coliform bacteria and other pathogens harmless.

The contents in process tank discharged to the filtration system for processing. A calculated amount of recovered water supplied from storage tank (suggested 30 gallons) via a circulating pump to the process tank to aid with thorough filtration and separated as recovered wastewater and slurry waste. Recovered wastewater sent to recovery tank and the excess recovered wastewater sent to disposal medium or to transfer pipe.

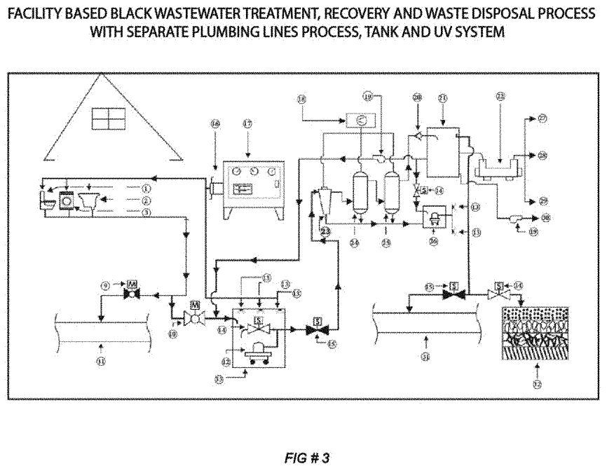

The recovered stored wastewater disbursed directly from storage tank as toilet flush water, irrigation lawn water, or as pool make up water. Additionally stored recovered water be processed through on-demand UV, treatment system FIG. 2. and be used as laundry water and as outside house water uses e.g., car washing etc. The recovered water processed through Reverse Osmosis Machine as reclaimed water be used for showering and kitchen uses etc.

Backwashed slurry waste sent as to slurry waste tank for further treatment and disposal. Daily disposal rates for a facility-based system will be as follows: minimal disposal of about 417 gm of solid waste plus an undetermined amount of toilet paper, food, fatty tissue, cleaning agent remnants and the recovery of 6.75 liters of water.

A simple method of disposal of wastewater slurry waste by pumping the waste into a perforated basket, allowing the wastewater to drain; leaving a residue mixture of grounded toilet paper mixed with fecal and urine solids, food remnants, undissolved fats and soap remnants. This residue can be used wet or dried as a soil amendment. Hypochlorous acid is a sanitizer and disinfectant and will eliminate any odors from the residue mixture.

These and other features, and advantages of the present invention will become more readily apparent from the attached drawings and the detailed description of the preferred embodiments, which will follow.

### DRAWINGS

### 1. A Detailed Description of the Invention Will be Made Referencing the Accompanying Drawings.

FIG. 1. Depicts a facility-based black and gray wastewater treatment, recovery and waste disposal process. This process treatment can be adapted to an existing single-family home connected to the city sewer or connected to a septic system and be easily converted to a independent facility-based wastewater treatment system. The primary importance of the process is the neutralization of coliform and other bacteria found in domestic treated wastewater at the source, the safe return of pathogen free wastewater to the soil and safe water for domestic usage.

FIG. 2. Depicts a facility-based black and gray wastewater treatment, recovery and waste disposal process with on-demand UV, treatment of recovered water as needed. This process treatment can be adapted to an existing house connected to the city sewer thereby converting it to an independent facility-based treatment unit with the ability to process and reuse treated wastewater for limited use.

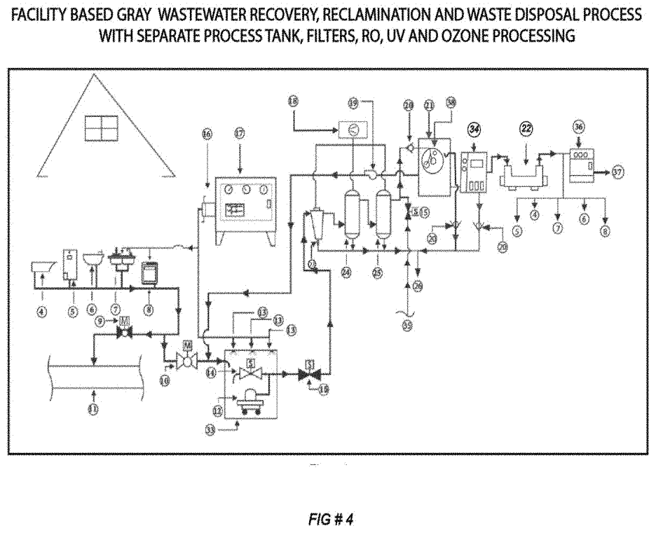

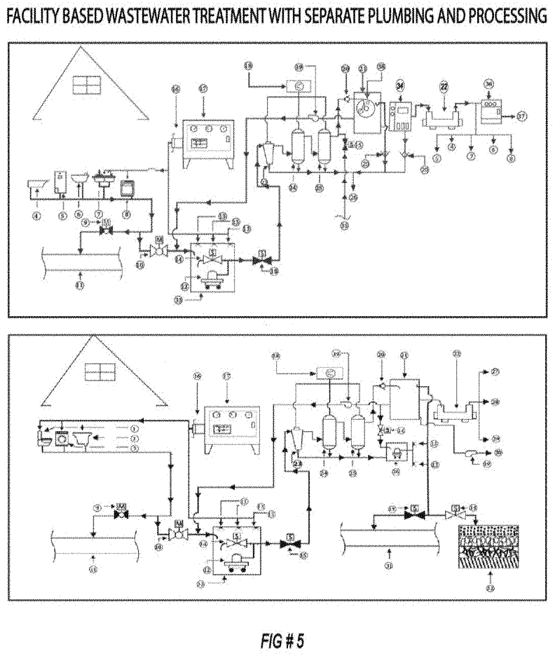

FIG. 3. Depicts a facility-based black wastewater treatment, recovery and waste disposal process with separate plumbing lines, process and storage tank and UV, system for limited recovered water reuse.

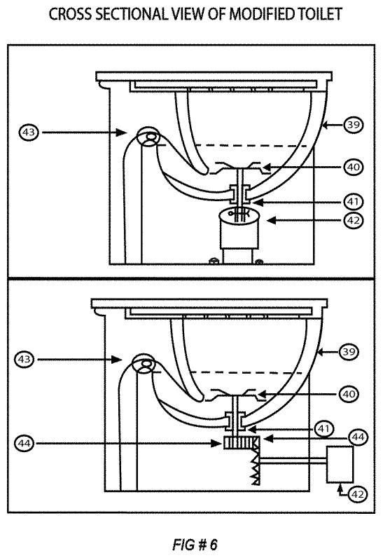

FIG. 4. Depicts a facility-based gray wastewater treatment, recovery and waste disposal process with separate process tanks, reverse osmosis, UV, and ozone treatment process. The recovered water reclaimed to potable standards for inside house water uses. The back flushed wastewater from the reverse osmosis system can be used for outside lawn irrigation

FIG. 5. Depicts a facility-based black and gray wastewater treatment with separate plumbing and processing. This system can be used in new home construction. This process treatment design will make available recovered gray wastewater for further treatment and reuse. This process treatment will yield between 70-80% savings of city supplied water to the facility daily.

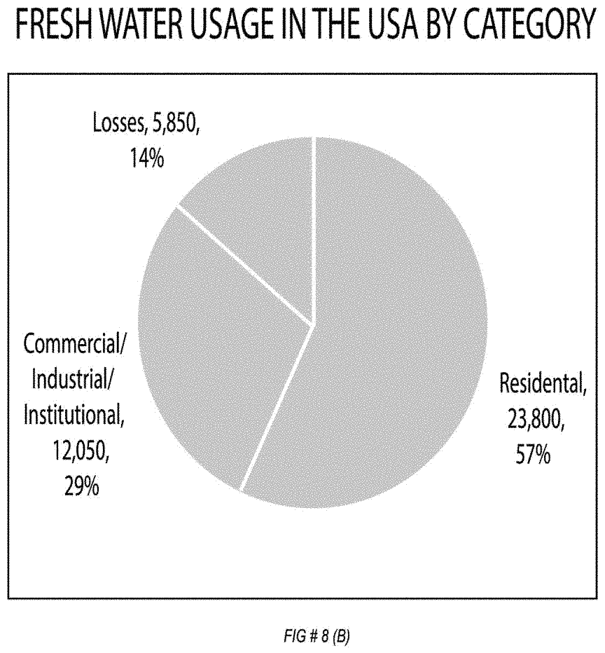

FIG. 6. Depicts cross-sectional views of modified toilets with vortex grinding mechanism and an anti-syphon valve to prevent unwanted discharge of processed waste matter during the grinding process.

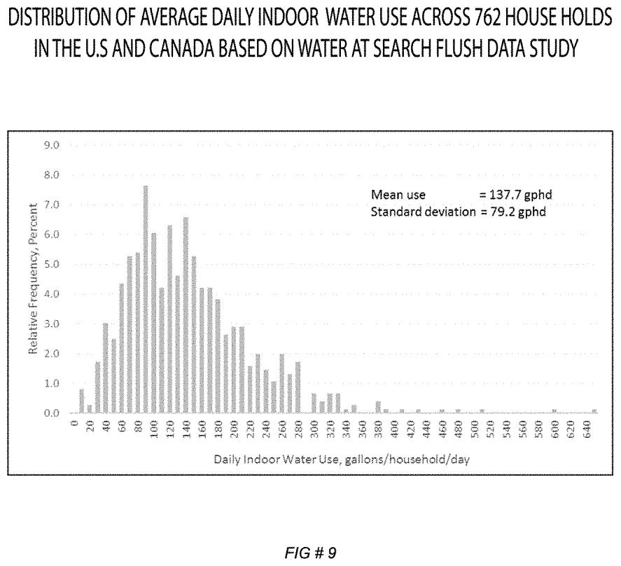

FIG. 7. Depicts a standard toilet mounted on a process box equipped with a grinder pump and motorized discharge valve. This is an alternative design to a modified toilet that will neutralize harmful pathogens and achieve the same result of mixing and grinding fecal, urine and cleaning tissue as processed in the modified toilet.

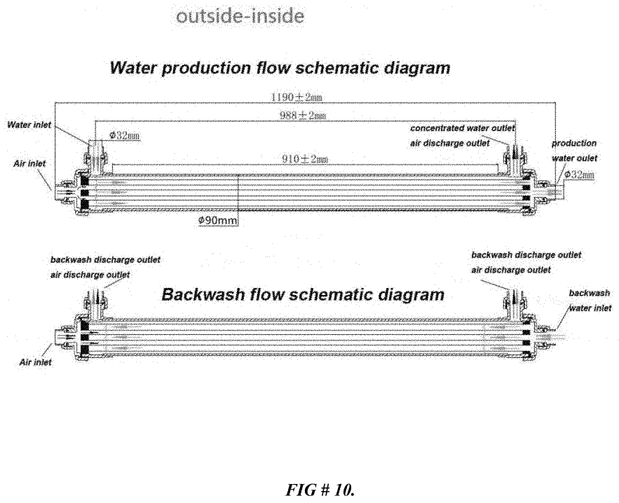

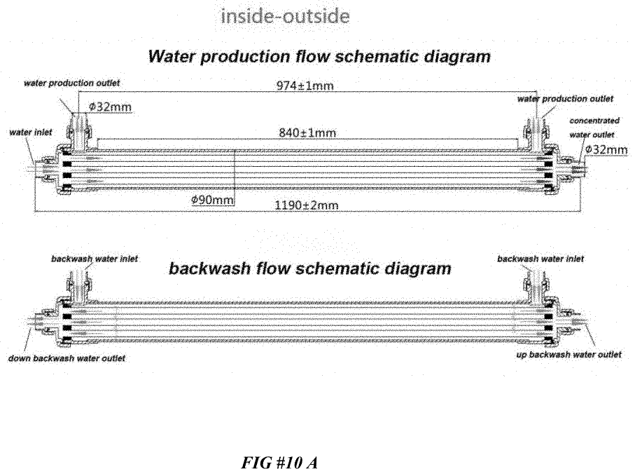

FIG. 8(A). Presents a graphical depiction of the household daily percentage water usage per utility, of the total available indoor water per household and based on a survey of nearly 800 households in the U.S. and Canada.

FIG. 8(B). Presents a graphical depiction of the percentage of U.S. residential domestic indoor water usage by category. As depicted in the graph daily domestic indoor freshwater allocated as drinking water is a small fraction of the total amount of freshwater used daily in U.S. households. The remaining freshwater used is discharged to the municipal sewer line or septic system rendering it unsafe for human and animal consumption. Most of the freshwater usage in the United States is by residential facilities. i.e., single family homes, condominiums, and large apartment complexes

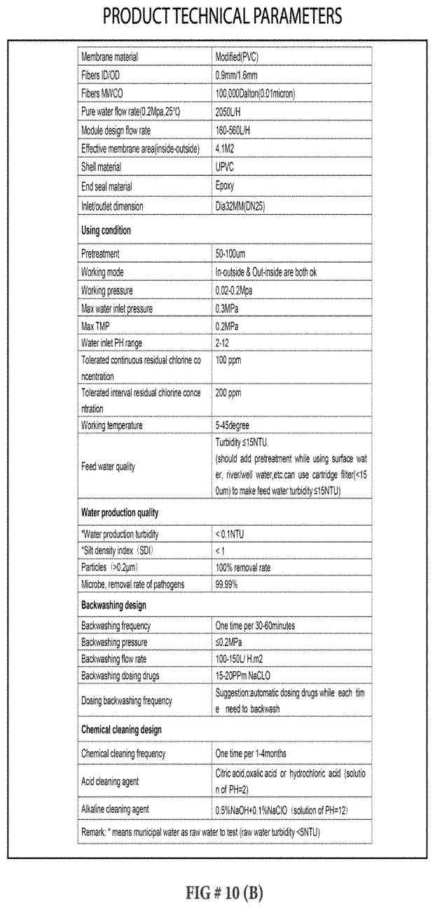

FIG. 9. Depicts a bar chart showing the mean average daily water usage of 137.7 gphd and a standard deviation of 79.2 gphd per household per day within the U.S. and Canada across 762 households.

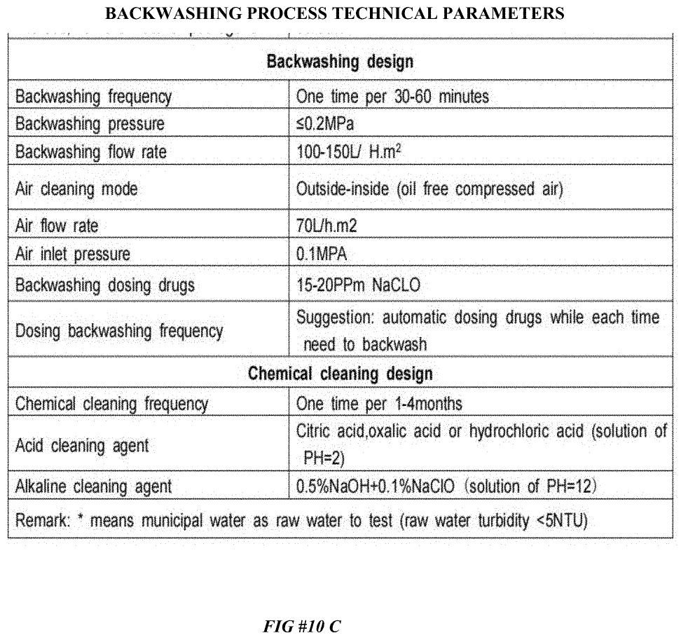

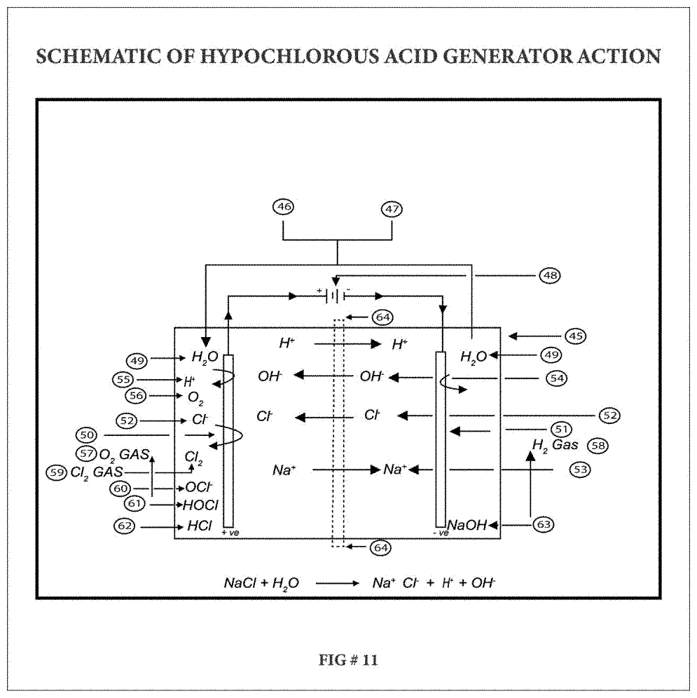

FIG. 10 & FIG. 10A. Presents a cross sectional view of a membrane filter “with outside in and inside out” water production flow and air aided backwashed water flow to help understand the separation process of recovered water and slurry waste.

FIG. 10(B). & FIG. 10C. Depicts two charts with the pertinent filter parameters such as filter membrane characteristics, filter construction, usage parameters and backwash and chemical cleaning requirements.

Permission to reproduce chart and diagram obtained from YOUBER—Ms. Nico sales5@youberchina.com

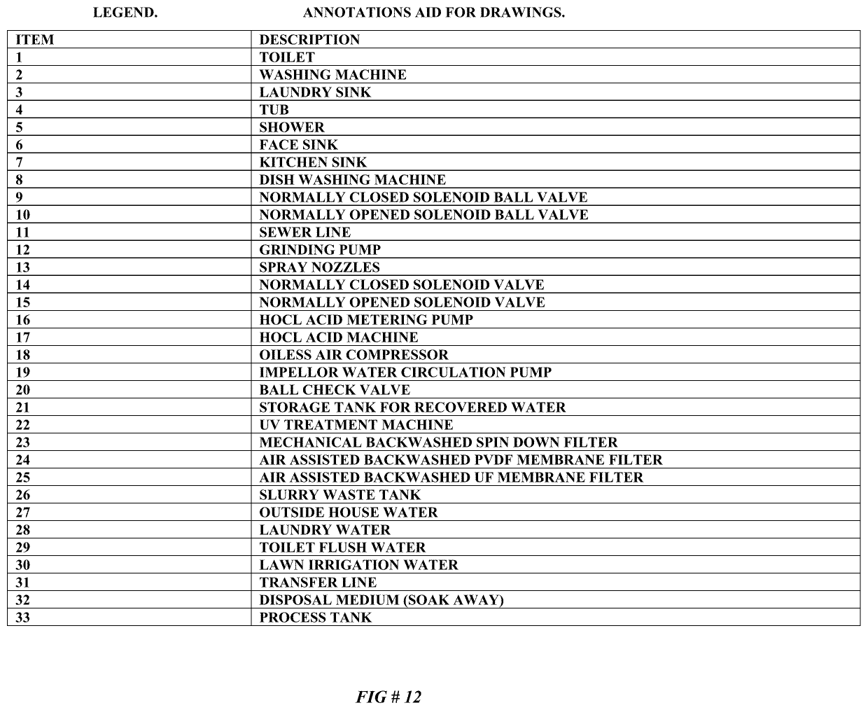

FIG. 11. Shows a schematic of Hypochlorous Acid Generator to aid review of the Hypochlorous Acid generation process and to help understand the ease and safety in producing Hypochlorous Acid and its effectiveness as USDA approved disinfectant and sanitizer.

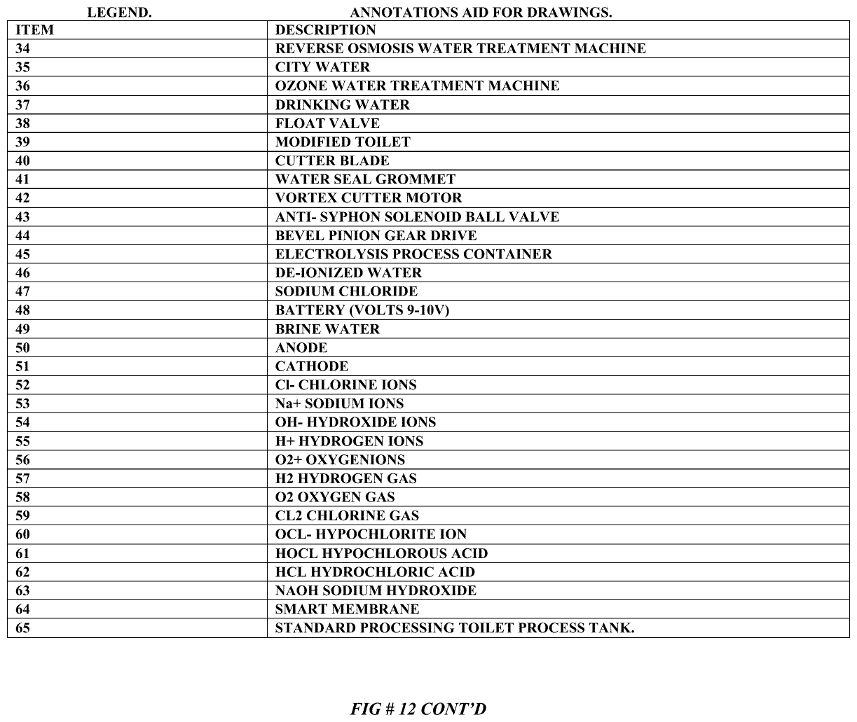

FIG. 12. Shows a Legend/Annotation Chart to aid ease of component identification and process concept of drawings.

### DETAILED DESCRIPTION

1. Detailed Description Such that any Person Skilled in the Art or Science can Make and Use Invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

The implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, summary, or the following detailed description.

It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not considered as limiting, unless the claims expressly state otherwise. Shown throughout the figures, the present invention is directed toward a facility-based wastewater treatment, reuse and waste disposal process.

### Hydrochlorous Acid Production and Uses Explained.

Hypochlorous acid production and analysis as best sanitizer to treat Escherichia coli, Listeria monocytogenes and Salmonella bacteria. (Coliform bacteria found in human stool and fresh and raw foods). Source:—www.amsusda.gov. Hypochlorous Acid TR 08 13 15. Hypochlorous Acid—Agricultural Marketing Service. Additional Source:—www.Nim.nih.gov. —: Journal of Oral and Maxillofacial Surgery. Hypochlorous Acid:—A Review by Michael. S. Block, DMD and Brian G. Rowan DMD, MD.

HOCL (hypochlorous acid) is an endogenous substance in all mammals and is effective against a broad range of microorganisms. HOCL made by combining non-iodinated salt, water, and electrolysis. The system reviewed to make HOCL on-site is a 1-liter container that is filled with water to which 1 gram of non-iodized salt and 1 teaspoon of vinegar are added. The system can make concentrations of 50 to 200 ppm (1 ppm equals 1 mg/L) in 8 minutes with a push of a button on a smart HOCL machine.

### HOCL Technical Analysis.

Hypochlorous Acid (61) (also referred to as electrolyzed water, EW) is an oxyacid of chlorine with formula HOCL. It is a weak acid and highly unstable and can exist in a solution. EW is produced by electrolysis as shown in FIG. 11.

EW is the product of the electrolysis of a dilute NaCl solution 49 in an electrolysis cell, having a semi-permeable membrane 64 that physically separates the anode 50 and cathode but permitting specific ions to pass through.

The voltage between the electrodes 48 set at 9 to 10 volts during electrolysis. Sodium chloride NaCl 47 dissolved in deionized water 49 dissociates into negatively charged chloride Cl− 52 and positively charged sodium ions Na+ 53. At the same time, hydroxide OH− 54, and hydrogen (H+) 55, ions are formed. Negatively charged ions Cl− 52, and OH− 54, moves to the anode to lose electrons and form 56, oxygen gas O2 56 chlorine gas Cl2 59 hypochlorite ion OCl−, 60 hypochlorous acid HOCl 61, and 62, hydrochloric acids. Positively charged ions such as H+ 55, and Na+, 53, move to the cathode to form hydrogen gas H2, 57, and 63 sodium hydroxide NaOH 63.

The solution separates into an acidic solution on the anode side of the membrane 64 with a pH of 2 to 6.0, an oxidation-reduction potential (ORP) of ≥1,000 mV, and a chlorine content of 10 to 90 ppm, and a basic solution on the cathode side of the membrane 64 with a pH of 7.5 to 13 and an ORP of ˜−800 to −900 mV.

The solution from the anode is acidic electrolyzed water (EW) 61 and the cathodic solution known as basic EW. Neutral EW, with a pH of 6 to 7.5 and an ORP of 750 mV, is produced by mixing the anodic solution with OH− ions 54. The solution from the anode is called acidic electrolyzed water, acid oxidizing water, or electrolyzed oxidizing water, and the cathodic solution is known as basic electrolyzed water, alkaline electrolyzed water, or electrolyzed reducing water.

There are several EW-producing machines available in the marketplace. The effectiveness of hypochlorous acid 61 as an active sanitizing agent is figured out in large part by the pH, a measure of the acidity or hydrogen ion concentration of the solution.

At an acidic to neutral pH, 6-7.5 pH the predominant chemical is hypochlorous acid HOCl 61, with a high oxidation reduction potential and has received recent attention as an alternative to other chlorine disinfectants and sanitizers.

Sanitizing means reducing the microorganisms of public health importance to levels considered safe, without adversely affecting either the quality of the product or its safety. EW is as effective as any chlorine treatment and is an alternative to other potentially dangerous chemicals, e.g., chlorine gas 59 chlorine dioxide, and bleach.

The apparatus to produce EW is inexpensive and easy to operate, because only water and sodium chloride are used. EW production is environmentally friendly, and the properties of the EW can be controlled at the preparation site.

HOCL Acid 61 has a shelf life of 4 days when exposed directly to sunlight and 14 days when sheltered from sunlight. HOCl Acid 61, can inactivate a variety of viruses including CORONA VIRUSES in less than 1 minute contact time at concentrations of 200 PPM. It can be used in liquid and aerosol forms.

At a pH of 6.0-7.5 (neutral), EW (ORP=750 mV) holds primarily hypochlorous acid. The effectiveness of neutral EW as a sanitizer has been proven to incapacitate Escherichia coli, Salmonella enteritidis and Listeria bacteria. This is primarily the reason Hypochlorous Acid 61 was chosen as the neutralizing agent for the facility-based wastewater neutralization process.

Characterization of feces and Urine. By C. Rose A. Parker and E. Cartmell. (www.ncbi.nlm.nih.gov)

Median fecal wet mass production was 128 g/cap/day per unit discharge. Dry Mass of 29.5 g/cap/day. Feces were composed of 74.6% of water or 0.09851 liter of water and 23.4% dry mass or 29.5 grams. Median urine generation rates were 1.42 L/cap/day with dry solid content of 64 g/cap/day. Urine is 91 to 96% water per discharge volume. Dry urine solids are consisting of 58-64 g/cap/day per person. Combined solid waste discharge fecal and urine discharge per person per day is (29.5 g/cap/day/person) and (64 g/cap/day/person). A total of 93.5 g/cap/day/person solid waste matter and (0.09851 liters water from feces and 1.349 liters of water from urine) or 1.4475 liters of reclaimed water.

The above data shows water and dry mass data collected for unit daily fecal and urine discharge per person. The data shows the volume of water in liters and weight of dry mass fertilizer in grams, recovered per unit daily discharge.

Analysis of 0.5 million discharges per day or 100,000 facility discharges (average facility consists of 5 persons) to a wastewater treatment plant show:

Recovered stool discharge waste: 49,250 liters of stool water and 14,750 kg of recovered dry stool to be disposed of daily, plus additional cleaning tissue.

Recovered Urine discharge waste: 675,000 liters of water from urine and 46,675 kg of solid waste from urine to be disposed of daily.

Analysis of combined fecal and urine waste disposal for 100,000 widely distributed facility-base units (e.g., single family homes with an average household of 5 member). Daily calculated dispersed disposal of about 467.5 gm of solid waste plus an undetermined amount of toilet paper and other waste residue (fat residue, food particles, soap residues mixed with cleaning tissue) and the addition of 7.24 liters of water per facility to be disposed of daily.

Analysis: Patent concept establishes an argument that individual facility-based domestic wastewater treatment systems offers a simplified and environmentally sound method of waste accumulation and disposal versus currently used waste water treatment process.

There are many iterations of the proposed patent concept of a facility-based rapid waste neutralization system. One iteration FIG. 1. is a system with a modified toilet 39, chemical dispenser 17, filtration units 23, 24 & 25, recovery storage tank 21, slurry waste accumulation tank 26 and disposal nozzles 13. This iteration can be easily adapted to residential facilities such as existing single-family homes, condominiums, and apartment complexes etc.

This iteration has a modified toilet 39 which incorporates a motor 42 and driven cutter 40 that uses blender-like action to pulverize the fecal mass, urine, and cleaning tissue. A multitude of grinding and mixing arrangements can be adapted to thoroughly grind and mix contents, chemically treat and also facilitate ease of filtration of wastewater. The toilet 39 is fitted with an anti-syphon ball valve 43 in the syphon discharge tube to prevent the premature discharge of the fecal batch during the cutting process.

A precise amount of Hypochlorous Acid 61 is added to the flush tank water (not shown). During the flushing process, chemically charged flushing water (100-200 ppm HOCL) neutralizes the fecal charge, sanitizes and deodorizes the toilet 39, cutter blades 42 and the plumbing system.

The treated charge upon being flushed is transferred via the plumbing lines to process treatment tank 33 where it is mixed with residual utility water contained in tank 33. The below grade process tank 33 cover is fitted with an array of spray nozzles 13 that dispenses a precise charge of hypochlorous acid 61 to the tank walls and contents. A grinder pump 12 is fitted in the base of 33 and it intermittently grinds and recirculates the contents until a discharge signal is sent by the process board. The process board is an electronic programmable controller unit that employs a series of sensors, timers, valves, and controllers to assist with system processing. A fill water level sensor activates the discharge and filtration process and powers water pump 19 supplying recovered water from tank 21 to assist with the filtration process. Normally opened solenoid valve 14 is closed, and normally closed valve 15 is opened allowing treated wastewater discharged to filters 23, 24 & 25 to be separated into recovered water and slurry waste.

A calculated amount of recovered water is supplied from storage tank 21 (suggested 30 gallons, computed on pump flowrate and pump operating time, controlled by the process timer) via circulating pump 19 to process tank 33 to aid with the thorough filtration of treated wastewater which is separated into recovered wastewater and slurry waste. Recovered wastewater is sent to storage tank 21 and the excess recovered wastewater is sent to disposal medium 32 or to transfer pipe 31.

The recovered stored wastewater can be used directly from the tank 21 as toilet flush water, irrigation lawn water, or for pool make up water. Additionally stored recovered water can be processed through an on-demand UV, treatment system 22; water to be reused for laundry and outside house use such as car washing etc. The recovered water can also be processed through a Reverse Osmosis Machine 34 to reclaimed water status for inside house usage such as showering, and kitchen uses. Backwashed slurry waste is sent as to slurry waste tank 26 for further treatment and disposal.

A simple method of disposal of wastewater slurry waste is to pump/spray the waste into a perforated basket and allow the wastewater to drain, leaving a residue mixture of grounded toilet paper mixed with fecal and urine solids, food remnants and undissolved fats and soap remnants. This residue can be used wet or dried as a soil amendment. Hypochlorous Acid 61 is a sanitizer and disinfectant that will eliminate odors from the solid waste residue.

Another iteration is a standard toilet mounted upon rectangular process box 65 equipped with a grinder motor 12, to pulverize the process batch mixed with a precise amount of Hypochlorous Acid 61 to neutralize the harmful pathogens and bacteria and discharged via discharge valve 43.

In each iteration the chemical metering pump 17 dispenses a fixed amount of chemical to a volume of flush water within the system to serve as the primary neutralizing agent necessary to kill harmful bacteria and to sanitize and deodorize the toilet bowl, cutting blades plumbing lines and process tank.

The system uses a secondary process tank 33 to chemically treat and neutralize processed and unprocessed wastewater sent to the tank. The tank cover is equipped with an array of spray nozzles 13 and dispenses a precise chemical charge to the tank and contents. A grinder pump 12 is fitted in the base of the process tank 33 that grinds the process batch for a programmed amount of time based on timer settings and recirculates contents via a normally open solenoid valve 14 to the process tank. Process batch contents are ground to a fineness of about 300-500 microns and then discharged via normally closed solenoid 15 valve to filtration units 23, 24 & 25.

The system is equipped with a recovery storage tank 21 that stores recovered water. During the discharge to the filtration units 23, 24 & 25 the normally closed discharge solenoid valve 15 opens and simultaneously circulating water pump 19 transfers water from the recovery storage tank 21 to the process tank 33 to ensure the treated wastewater is thoroughly filtered.

All filters will be backwashed after each process discharge from process tank 33. The backwashing of filters thoroughly unclogs and chemically treat filter media.

Membrane filters are soaked with wastewater containing 100-200 ppm of HOCL Acid. This wetness of membrane filters reduces the need for quarterly chemical treatment with citric and or hydrochloric acid as per chart in FIG. 10C.

In yet another aspect FIG. 3. a new construction facility-based wastewater recovery system can include a treatment system having separate plumbing lines separating black water from gray water and sending wastewater to different processing tanks for further treatment and processing. Plumbing lines inter-connects the toilet 39 the clothes washer 2 and wash-sink 3 and extends plumbing line connection to a separate process tank 33.

Separate black wastewater processed as shown in FIG. 2. is treated, recovered and stored in a storage tank for reuse as toilet flush water and other outside house uses such as lawn and irrigation water. The excess recovered wastewater free from pathogens is sent to specially designed filtration soak away bed 32 for rapid return to ground water or sent to a transfer pipe 31 to be used elsewhere as required.

In another iteration FIG. 4. depicts a gray wastewater treatment system with separate plumbing lines that connects the kitchen sink 7, dish washer 8, face sink 6, tub 4, shower 5 and discharges wastewater into a separate process tank 33. Gray wastewater is chemically treated in a separate process tank 33 and sent to a separate filtration system unit 23, 24, & 25. This system separates the treated gray water into recovered gray wastewater which is processed and reclaimed for indoor water usage using Reverse Osmosis machine 34. The back-washed wastewater from Reverse Osmosis can be used for irrigation or can be sent to the soak away for disposal.

100% of the recovered gray water stored into a separate storage tanks 21 to be reclaimed to potable standards using a combination of Reverse Osmosis process 34 UV, treatment 22 and Ozone treatment 36. The backwashed content is sent to the slurry waste tank 26 for storage, processing and disposal.

Recovered water stored in tanks can be for irrigation purposes. Some of the recovered water can be stored in another tank designated for reverse osmosis treatment and be reused as laundry water, toilet flush water, swimming pool water and outside house water.

In another aspect, commercial facility based rapid waste neutralization systems can include separate plumbing lines for new constructions, with separate plumbing arrangements and connections to different processing machines as needed. Also, system can be configured to use multiple modified toilets, secondary process tanks, HOCL machines, filtration units, storage tanks and waste processing tanks as needed to satisfy differing processing capacities.

In yet one other aspect, the facility-based wastewater recovery system can include at least one of a plurality of filtration units having a polyvinylidene difluoride membrane filter (PVDF) 24 to remove chemical waste such as perchloroethylene, sometimes found in laundry wastewater, and waste discharges from other plumbing units in a facility and the removal solid particulates having an effective diameter of 0.01 microns or greater.

In still one other aspect, the facility-based wastewater reclamation system may have multiple spin down filters 23 from 40 um to 90 um to help separate the cleaning paper fibers and allowing recovered water free of fibers to enter the membrane filters effectively removing bacteria and other fecal particles less than 0.01 micron.

In yet another aspect filtration unit can include ceramic flow through nano filter to further remove bacteria and solids up to a fineness of 0.01 micron.

In another iteration any array of CTO filters can be installed to treat and enhance the color, odor and taste of reclaimed gray water.

In yet another aspect, the facility-based wastewater reclamation system can include a Reverse Osmosis unit 34 to remove free ions and other contaminants contained in the amount of recovered and reclaimed wastewater dispensed from on-demand ozone unit 36 as drinking water.

In at least one embodiment FIG. 1. the present invention can reduce freshwater demand by about 40% to about 50% depending on outside water usage, which includes but not limited to replenishing swimming pools water, toilet flush water, laundry water, landscaping and irrigation water needs, car washing and fountains etc. just to name a few. As will be appreciated, fresh water may be supplied by a municipal water treatment facility, well water, and or fresh water collected and contained in cisterns or reservoirs proximate the facility.

In another embodiment shown in FIG. 5. the process can reduce city water demand by about 70-80%. This is achieved by processing and treating all recovered wastewater generated at a facility. Black recovered wastewater treated with on-demand UV, machine 22 as laundry water, for car washing and other outside house uses. Toilet flush water and irrigation water are withdrawn from storage tank with no additional treatments and 100% of recovered gray water processed via Reverse Osmosis for indoor house use.

As will be further appreciated, the present system may be installed in new construction as shown in FIG. 5. with appropriate plumbing lines and discharge arrangements and can be modified as required. A central control unit comprising of timers, control valves, solenoids, and other logic control programmable functions such as are known, may be employed with the present system to automate operation.

In another iteration the above-described process can be adapted to multifamily domestic residences. In this iteration multiple process tanks and modified toilets with large HOCL Acid producing machines are needed to process the larger discharge capacities because of the increased number discharge outlets. Considerable design analysis to accommodate the new capacity is necessary to successfully process the increased wastewater capacity. This can be successfully done at a cheaper cost and safely process the new designed capacities.

Since many modifications, variations, and changes in detail can be made to the described preferred embodiments of the invention, it is intended that all matters in the foregoing description and shown in the accompanying drawings be interpreted as illustrative and not in a limiting sense.

Furthermore, it is understood that any of the features presented in the embodiments may be integrated into any of the other embodiments unless explicitly stated otherwise. The scope of the invention should be determined by the appended claims and their legal equivalents.

Benefits of the combined embodiments includes water conservation without restricting water usage, reduction of freshwater demand thereby alleviating the impacts of drought, providing additional water availability for use in firefighting efforts, agricultural and manufacture usage, minimizing if not ultimately eliminating altogether the need for sewage transmission lines and municipal wastewater treatment facilities.

The reduction of and possible elimination of raw sewage discharges, sanitizing, disinfecting, and eliminating foul odors associated with facility plumbing system and sulfur gas discharges associated with water treatment plants. The recharging of groundwater reserves, and a significant reduction in the manufacture, and subsequent disposal, of plastic drinking water bottles by increasing the availability of reclaimed water for potable water usage, just to name a few.

Finally a facility base rapid wastewater treatment process that offers real world solutions comprising:
a. An outcome for the reduction of water borne pathogens and spread of infectious diseases, resulting from chemical neutralization of pathogens at the source and the reduction of sewers and septic collectors globally.
b. An outcome curtailing environmental contamination of water bodies resulting from intended wastewater reuse and disposal methods globally.
c. An outcome to limiting the production of (CHG/GhG) greenhouse gasses because of anticipated reduction of biological wastewater processing and the anticipated use of more green energy to power facility-based processing.
d. An outcome to address and curtail global fresh water rapid depletion resulting from the conservation of city supplied water, to facilities with estimated daily savings of 50-70% due to recovery, reclamation, and reuse of treated wastewater
e. A machine design concept offering ease of use, safety, affordability, scalability and as an alternative process to current expensive wastewater management systems employed globally.
f. A facility-based rapid domestic wastewater treatment process as a replacement for current wastewater treatment processes.

What is claimed is:

1. A facility based rapid domestic wastewater treatment process for treating coliform bacteria in bodily excretions and other utility wastewater pathogens at the source comprising:
a. One or more modified toilets as primary treatment source.
b. One or more secondary process tanks as secondary treatment source.
c. One or more hypochlorous acid production machines.
d. One or more filtration processing system.
e. One or more recovery and reclamation water storage tanks.
f. One or more recovered and reclamation water purification machines.
g. One or more slurry waste accumulation tanks with disposal system.
h. One or more plumbing configurations for utility wastewater discharge.
i. One or more programmable controllers sequencing processing instructions and sub routine functions.

2. A facility-based process as claimed in claim 1 that incorporates modified toilets as primary treatment sources, equipped with an electrical motor and cutting blades, anti-syphon ball valve and flush water charged with 100-200 ppm of Hypochlorous Acid.

3. A facility-based process as claimed in claim 1 that incorporates secondary process tanks as secondary treatment source, equipped with a grinding motor, process chemical dispensing nozzles, recirculating, and discharge solenoid valves to thoroughly mix, recirculate, and grind toilet and other facility utility solid waste discharges to a fineness of 300-500 microns prior to discharging to a filtration unit for processing.

4. A facility-based process as claimed in claim 1 that incorporates a Hypochlorous Acid machine that produces, stores, and dispenses 100-200 ppm at a pH range 6-7.

5. A facility-based process as claimed in claim 1; comprising of a filter array inclusive of air assisted backwashed spin down mechanical filter, PVDF and UF membrane filter and ceramic nano filters to separate wastewater into recovered water and slurry waste and the separation of bacteria and other particulates up to or equal to a fineness of 0.01

6. A facility-based process as claimed in claim 1 of recovered and reclaimed water storage tanks to store treated wastewater for reuse and additional processing.

7. A facility-based process as claimed in claim 1; the use of water purification machines, Reverse Osmosis, UV, and Ozone treatment for processing treated wastewater for outdoor and indoor facility use and as drinking and cooking water.

8. A facility-based process as claimed in claim 1 showing a rapid domestic wastewater treatment process outlined in FIG. 5 having separate plumbing lines with the appropriate plumbing system discharge arrangements.

9. A facility-based process claimed in claim 1 comprising one or more slurry waste accumulation, processing, and disposal tanks inclusive of grinding motor, solenoid discharge valve and discharge nozzles.

10. A facility-based process as claimed in claim 1 inclusive of a controller system comprising of timers, control valves, solenoids, within a central control unit, such as are known, may be employed with the present system to automate operation.

11. A facility-based process as claimed in claim 1; all filters shall be backwashed after each process discharge from process tank. The backwashing of filters thoroughly unclogs filter media and chemically treat filter media.
